(19) United States
(12) Patent Application Publication
(10) Pub. No.: US 2021/0360418 A1
(43) Pub. Date: Nov. 18, 2021

(54) FLEXIBLE USAGE DATA COLLECTION FOR ENVIRONMENTAL SENSING CAPABILITY IN A SHARED SPECTRUM

(71) Applicant: Nokia Solutions and Networks Oy, Espoo (FI)

(72) Inventors: Mohammad Riaz Khawer, Wayland, MA (US); Milind M. Buddhikot, Bridgewater, NJ (US)

(21) Appl. No.: 17/273,972

(22) PCT Filed: Sep. 7, 2018
(86) PCT No.: PCT/US2018/049990

§ 371 Date: Mar. 5, 2021

(51) Int. Cl. H04W 16/14; H04W 60/00; H04L 12/26

(52) U.S. Cl. CPC H04W 16/14; H04L 43/10; H04W 60/00

(57) ABSTRACT

An environmental sensing capability (ESC) cloud includes a transceiver configured to exchange heartbeat messages with one or more spectrum access servers (SASs) that are registered to receive ESC services for a shared spectrum. The ESC cloud also includes a processor configured to increment an ESC usage for the one or more SASs in response to successfully exchanging one or more heartbeat messages with the one or SASs in a predetermined time interval. In some cases, the ESC usage is associated with a dynamic protection area (DPA) that defines a local protection area that is activated or deactivated as necessary to protect Department of Defense (DOD) radar systems in the shared spectrum.

### BACKGROUND

Spectrum is the most precious commodity in deploying wireless networks such as a private enterprise network. Cellular communication systems, such as networks that provide wireless connectivity using Long Term Evolution (LTE) standards, provide more reliable service and superior quality-of-service (QoS) than comparable services provided by conventional contention-based services in unlicensed frequency bands, such as Wi-Fi. The most valuable spectrum available for cellular communication is at frequencies below 6 Gigahertz (GHz) because transmissions at these frequencies do not require a clear line of sight between the transmitter and the receiver. Much of the sub-6-GHz spectrum is already auctioned off as statically licensed spectrum to various mobile network operators (MNOs) that implement cellular communication system such as LTE networks. The 3.1-4.2 GHz spectrum is occupied by incumbents such as Fixed Satellite System (FSS) and federal incumbents such as U.S. government or military entities. For example, the 3550-3700 MHz frequency band (CBRS band) was previously reserved for exclusive use by incumbents including the United States Navy and Fixed Satellite Service (FSS) earth stations. This band of the spectrum is often highly underutilized. Consequently, organizations and vertical industries such as package distribution companies, energy producers, ports, mines, hospitals, and universities do not have access to sub-6-GHz spectrum and are therefore unable to establish private enterprise networks to provide cellular service such as LTE.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a communication system according to some embodiments.

FIG. 2 is a block diagram of a network function virtualization (NFV) architecture according to some embodiments.

FIG. 3 is a block diagram illustrating an allocation of frequency bands and an access priority for incumbents, licensed users, and general access users according to some embodiments.

FIG. 4 is a block diagram of a communication system that implements tiered spectrum access according to some embodiments.

FIG. 5 is a block diagram of a communication system that implements a spectrum controller cloud to support deployment of private enterprise networks in a shared spectrum according to some embodiments.

FIG. 6 is a block diagram of communication system including interfaces between citizens broadband radio service devices (CBSDs) and a spectrum access system (SAS) according to some embodiments.

FIG. 7 is a map of the borders of the United States that illustrates a set of dynamic protection areas (DPAs) defined at different geographic locations within the United States according to some embodiments.

FIG. 8 is a block diagram of a cloud infrastructure that is used to perform environmental sensing within a geographic area such as a DPA according to some embodiments.

FIG. 9 is a block diagram of an environmental sensing capability (ESC) cloud according to some embodiments.

FIG. 10 is a block diagram of a communication system that includes an ESC cloud service to provide ESC services to registered SAS administrators according to some embodiments.

FIG. 11 illustrates a message sequence for messages exchanged between an SAS and an ESC cloud according to some embodiments.

FIG. 12 illustrates a heartbeat message exchange between an ESC cloud and two SAS instances in a DPA according to some embodiments.

FIG. 13 is a flow diagram of a method for determining usages of an ESC service by SAS instances in a DPA according to some embodiments.

FIG. 14 is a flow diagram of a method for determining usage charges for an ESC service provided to SAS instances in a DPA according to some embodiments.

### DETAILED DESCRIPTION

The Federal Communication Commission (FCC) has begun offering bands of spectrum owned by federal entities for sharing with commercial operations. For example, newly issued FCC rules in 47 Code of Federal Regulations (CFR) Part 96 allows sharing of the 3550-3700 MHz Citizens Broadband Radio Service (CBRS) between incumbents and other operators. The CBRS operates according to a tiered access architecture that distinguishes between incumbents, operators that have received a priority access license (PAL) consistent with 47 CFR § 96.23, et seq., and general authorized access (GAA) operators that are authorized to implement one or more Citizens Broadband radio Service Devices (CBSDs) consistent with 47 CFR § 96.33, et seq. Incumbents, PAL licensees, and GAA operators are required to request access from a spectrum access system (SAS), which allocates frequency bands to the operators, e.g., for CBRS within the 3550-3700 MHz band. The SAS is responsible for managing or controlling different types of CBSDs in the CBRS frequency bands. In current deployments, the CBSD are categorized as:
Category A—CBSDs designed for indoor deployments with a maximum transmission power limit of 30 dBm,
Category B—CBSDs designed for outdoor deployments with a maximum transmission power limit of 47 dBm.
CPE—CBSDs designed for use as customer premises equipment.

The frequency bands are allocated to the CBSDs associated with the operators within particular geographical areas and, in some cases, during particular time intervals. The SAS determines whether incumbents are present within corresponding geographical areas using an environmental sensing capability (ESC) that performs incumbent detection, e.g., using radar to detect the presence of a Navy ship in a port.

The tiered access architecture provides priority access to incumbents, which include Grandfathered Wireless Broadband Licensees that are authorized to operate on a primary basis on frequencies designated in 47 CFR § 96.11. When an incumbent is present in a particular geographical area, the incumbent is granted exclusive access to a portion of the CBRS spectrum. For example, if a Navy ship enters a port, communication systems on the ship are granted exclusive access to a 20-40 MHz band within the 3550-3700 MHz band. Operators that have received a PAL and GAA operators are required to vacate the band allocated to the ship. A PAL license grants exclusive access to a portion of the 3550-3700 MHz band within a predetermined geographical area as long as no incumbents have been allocated an overlapping portion of the 3550-3700 MHz band within the predetermined geographical area. The GAA operators are given access to a portion of the 3550-3700 MHz band within a geographic area as long as no incumbents or PAL licensees have been allocated an overlapping portion in the same geographic area during a concurrent time interval. The GAA operators are also required to share the allocated portion of the 3550-3700 MHz band if other GAA operators are allocated the same portion.

The Federal Communications Commission (FCC) and the National Telecommunications and Information Administration (NTIA) defines a set of dynamic protection areas (DPAs) along the east, west, and Gulf coasts of the United States. A DPA is a pre-defined local protection area that is activated or deactivated as necessary to protect Department of Defense (DOD) radar systems. All outdoor (Category B) CBSD within an activated DPA are required to stop transmission or reduce transmission to below a threshold transmit power. One or more ESC sensors deployed within a DPA detect the presence or absence of an incumbent. In some cases, an ESC cloud gathers information from a set of ESC sensors within a DPA and uses this information to detect incumbents. An ESC sensor (or cloud) transmits a report to the SAS for the DPA in response to the ESC sensor (or cloud) detecting the presence of an incumbent. The report includes information identifying the portion (e.g., 10-20 MHz) of the total 150 MHz CBRS spectrum that is impacted by the presence of the incumbent. In response to receiving the report, the SAS performs interference management using all the CBSDs within the DPA that are operating within the impacted frequency range. For example, the SAS can move the CBSD to a different channel or instruct the CBSD to operate with a lower transmit power to keep the interference level in compliance with FCC regulations. Lowering the transmit power reduces the transmission coverage area for the CBSD. A DPA can only be deactivated by an operational ESC sensor. Thus, the SAS and the ESC sensor (or cloud) maintain a constant heartbeat exchange to verify that an operational ESC sensor is present within the DPA. If there are no operational ESC sensors deployed within a DPA, the DPA must be activated throughout the entire 150 MHz CBRS spectrum. Moreover, no outdoor CBSDs (Category B) can be deployed in a DPA without an ESC sensor.

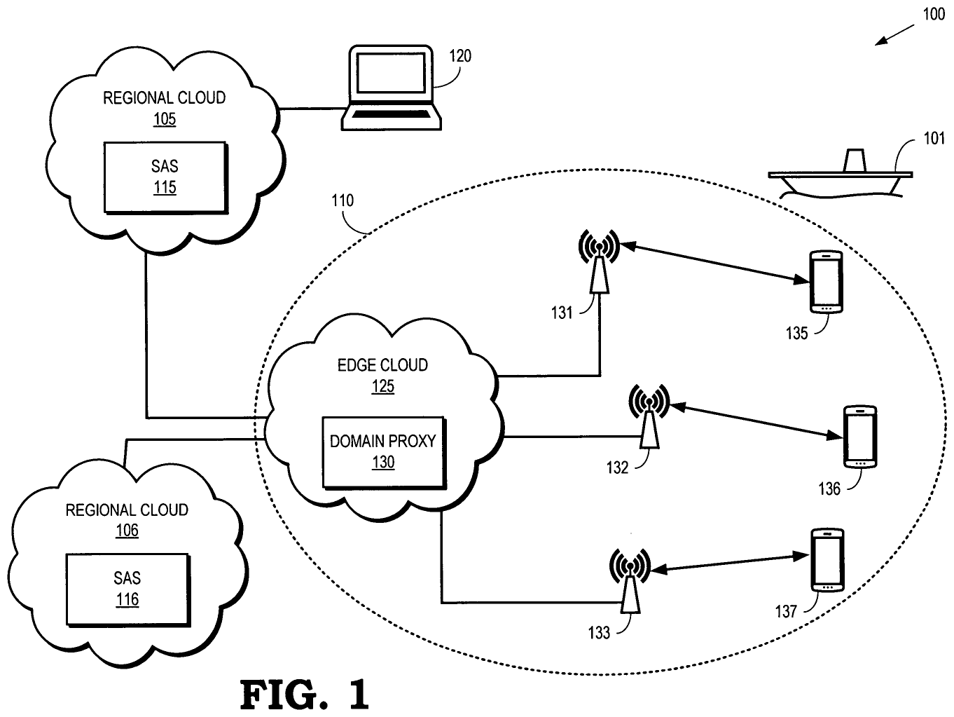

FIGS. 1-14 disclose a system that provides environmental sensing capability (ESC) sensors as a service to SAS administrators that subscribe to the ESC service within one or DPAs. However, SAS administrators should only be charged for actual usage of the ESC sensors and should not be charged if the ESC sensor is not operational. A flexible charging mechanism is therefore implemented to determine usage of the ESC sensors (or an ESC cloud) at a predetermined granularity, such as a per-minute basis, although other granularities can also be used. An SAS instance for a DPA registers with a corresponding ESC cloud and negotiates a periodicity for heartbeat messages exchanged by the SAS and the ESC cloud. The ESC cloud then begins monitoring for the presence of incumbents and provides periodic or asynchronous status reports to the SAS to indicate whether an incumbent is present. The ESC cloud and the SAS also exchange heartbeat messages at the negotiated periodicity. Usage of the ESC cloud within the DPA by the SAS is incremented by one minute (or other time interval such as an hour, a day, or a month) if the SAS and the ESC cloud successfully exchange a heartbeat message within the minute. The usage is not incremented if no heartbeat messages were successfully exchanged by the SAS and the ESC cloud. In some embodiments, an SAS administrator implements multiple regional clouds including geo-redundant instances of the SAS. In that case, the usage is incremented by one minute if at least one of the geo-redundant instances of the SAS successfully exchange heartbeat messages with the ESC cloud. The usage is not incremented if none of the geo-redundant instances of the SAS successfully exchange heartbeat messages with the ESC cloud. The ESC cloud also maintains a periodic heartbeat exchange with its ESC sensors deployed in the various DPAs. If the ESC sensors in a particular DPA lose connectivity with the ESC cloud, resulting in a loss of ESC sensor support in that particular DPA for incumbent detection and reporting, the ESC cloud would not count the ESC service usage associated with the DPA towards the SAS administrators who have registered to receive the ESC service in the DPA.

FIG. 1 is a block diagram of a communication system 100 according to some embodiments. The communication system 100 operates in accordance with the FCC rules set forth in 47 Code of Federal Regulations (CFR) Part 96, which allows sharing of the 3550-3700 MHz Citizens Broadband Radio Service (CBRS) between incumbents and other operators. However, some embodiments of the communication system 100 operate in accordance with other rules, standards, or protocols that support sharing of a frequency band between incumbents and other devices such that the frequency band is available for exclusive allocation to an incumbent device if the incumbent device is present in a geographic area. In that case, the other devices are required to vacate any portion of the frequency band that overlaps with another portion of the frequency band that is allocated to the incumbent device. For example, if the communication system 100 is deployed (at least in part) proximate a port and a Navy ship such as an aircraft carrier 101 arrives in the port, devices in a geographic area proximate the port that are providing wireless connectivity in a portion of the frequency band allocated to the aircraft carrier 101 are required to vacate the portion of the frequency band to provide the aircraft carrier 101 with exclusive access to the frequency band within the geographic area.

The communication system 100 includes a regional cloud 105 that provides cloud-based support for a private enterprise network 110. Some embodiments of the regional cloud 105 include one or more servers that are configured to provide operations and maintenance (O&M) management, a customer portal, network analytics, software management, and central security for the private enterprise network 110. The regional cloud 105 also includes an SAS instance 115 to allocate frequency bands to operators, e.g., to the private enterprise network 110 for CBRS within the 3550-3700 MHz band. The communication system 100 also includes another regional cloud 106 that includes an SAS instance 116. In the illustrated embodiment, the regional clouds 105, 106 are located at different geographic locations and are therefore used to provide geo-redundancy. For example, the SAS instance 115 can be selected as a primary SAS and the SAS instance 116 can be selected as a secondary, geo-redundant SAS. The SASs 115, 116 communicate with each other over an SAS-SAS interfaces (not shown in FIG. 1 in the interest of clarity). If additional SAS instances are present in the communication system 100, the SAS instances communicate with each other over corresponding SAS-SAS interfaces. The SASs 115, 116 can serve multiple private enterprise networks, although a single private enterprise network 110 is shown in FIG. 1 in the interest of clarity.

The regional clouds 105, 106 are configured via user interface portals to one or more external computers 120, only one shown in FIG. 1 in the interest of clarity. For example, the external computer 120 can provide a customer user interface portal for service management, a digital automation cloud management user interface portal, and an SAS user interface portal that is used to configure the SASs 115, 116.

The private enterprise network 110 includes an edge cloud 125 that communicates with the regional clouds 105, 106 to support a plug-and-play deployment of the private enterprise network 110. Some embodiments of the edge cloud 125 support auto configuration and self-service, industrial protocols, local connectivity with low latency, LTE-based communication and local security, high availability, and other optional applications for the private enterprise network 110. In the illustrated embodiment, the edge cloud 125 implements a domain proxy 130 that provides managed access and policy control to a set of CBSDs 131, 132, 133 that are implemented using base stations, base station routers, mini-macrocells, microcells, indoor/outdoor picocells, femtocells, and the like. As used herein, the term “base station” refers to any device that provides wireless connectivity and operates as a CBSD in the private enterprise network 110 as either category A CBSD (Indoor), Category B CBSD (outdoor), or customer premises equipment (CPE). The CBSDs 131, 132, 133 are therefore referred to herein as the base stations 131, 132, 133 and collectively as “the base stations 131-133.” Some embodiments of the domain proxy 130 are implemented in one of the regional clouds 105, 106.

The domain proxy 130 mediates between the SASs 115, 116 and the base stations 131-133. In order to utilize the shared spectrum, the base stations 131-133 transmit requests towards one of the SASs 115, 116 to request allocation of a portion of a frequency band. The other one of the SASs 115, 116 is used as a secondary SAS in case of a failure associated with the primary SAS. The requests include information identifying the portion of the frequency band such as one or more channels, a geographic area corresponding to a coverage area of the requesting base station, and, in some cases, a time interval that indicates when the requested portion of the frequency band is to be used for communication. In the illustrated embodiment, the coverage area of the base stations 131-133 corresponds to the area encompassed by the private enterprise network 110. Some embodiments of the domain proxy 130 reduce the signal load between the domain proxy 130 and the SASs 115, 116 by aggregating requests from multiple base stations 131-133 into a smaller number of messages that are transmitted from the domain proxy 130 to the SASs 115, 116. The base stations 131-133 provide wireless connectivity to corresponding user equipment 135, 136, 137 (collectively referred to herein as “the user equipment 135-137”) in response to the SASs 115, 116 allocating portions of the frequency band to the base stations 131-133.

The requests transmitted by the base stations 131-133 do not necessarily include the same information. Some embodiments of the requests from the base stations 131-133 include information indicating different portions of the frequency band, different geographic areas, or different time intervals. For example, the base stations 131-133 request portions of the frequency band for use in different time intervals if the private enterprise network 110 is deployed in a mall or shopping center and the base stations 131-133 are used to provide wireless connectivity within different stores that have different operating hours. The domain proxy 130 therefore manages the base stations 131-133 using separate (and potentially different) policies on a per-CBSD basis. In some embodiments, the domain proxy 130 accesses the policies for the base stations 131-133 in response to receiving a request from one of the base stations 131-133. The domain proxy 130 determines whether the requesting base station from which the request is received is permitted to access the SAS instance 115 based on the policy, e.g., by comparing information in the policy to information in one or more mandatory fields of the request. The domain proxy 130 selectively provides the requests to the SASs 115, 116 depending on whether the requesting base station is permitted to access the SASs 115, 116. If so, the request is transmitted to the SASs 115, 116 or aggregated with other requests for transmission to the SASs 115, 116. Otherwise, the request is rejected.

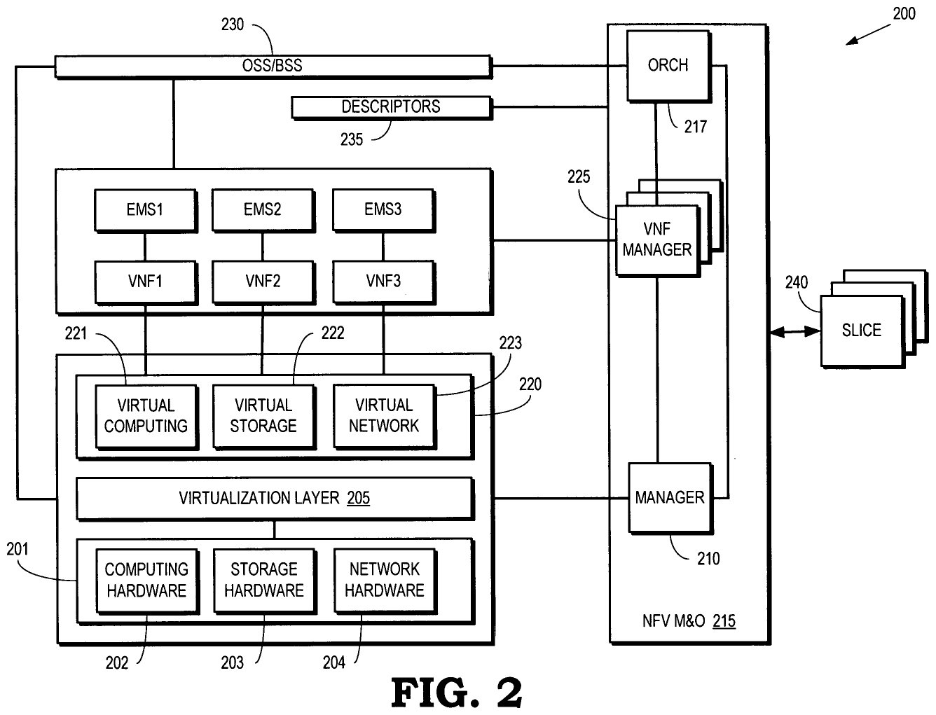

FIG. 2 is a block diagram of a network function virtualization (NFV) architecture 200 according to some embodiments. The NFV architecture 200 is used to implement some embodiments of the communication system 100 shown in FIG. 1. The NFV architecture 200 includes hardware resources 201 including computing hardware 202 such as one or more processors or other processing units, storage hardware 203 such as one or more memories, and network hardware 204 such as one or more transmitters, receivers, or transceivers. A virtualization layer 205 provides an abstract representation of the hardware resources 201. The abstract representation supported by the virtualization layer 205 can be managed using a virtualized infrastructure manager 210, which is part of the NFV management and orchestration (M&O) module 215. Some embodiments of the virtualized infrastructure manager 210 are configured to collect and forward performance measurements and events that may occur in the NFV architecture 200. For example, performance measurements may be forwarded to an orchestrator (ORCH) 217 implemented in the NFV M&O 215. The hardware resources 201 and the virtualization layer 205 may be used to implement virtual resources 220 including virtual computing 221, virtual storage 222, and virtual networking 223.

Virtual networking functions (VNF1, VNF2, VNF3) run over the NFV infrastructure (e.g., the hardware resources 201) and utilize the virtual resources 220. For example, the virtual networking functions (VNF1, VNF2, VNF3) may be implemented using virtual machines supported by the virtual computing resources 221, virtual memory supported by the virtual storage resources 222, or virtual networks supported by the virtual network resources 223. Element management systems (EMS1, EMS2, EMS3) are responsible for managing the virtual networking functions (VNF1, VNF2, VNF3). For example, the element management systems (EMS1, EMS2, EMS3) may be responsible for fault and performance management. In some embodiments, each of the virtual networking functions (VNF1, VNF2, VNF3) is controlled by a corresponding VNF manager 225 that exchanges information and coordinates actions with the virtualized infrastructure manager 210 or the orchestrator 217.

The NFV architecture 200 may include an operation support system (OSS)/business support system (BSS) 230. The OSS/BSS 230 deals with network management including fault management using the OSS functionality. The OSS/BSS 230 also deals with customer and product management using the BSS functionality. Some embodiments of the NFV architecture 200 use a set of descriptors 235 for storing descriptions of services, virtual network functions, or infrastructure supported by the NFV architecture 200. Information in the descriptors 235 may be updated or modified by the NFV M&O 215.

The NFV architecture 200 can be used to implement network slices 240 that provide user plane or control plane functions. A network slice 240 is a complete logical network that provides communication services and network capabilities, which can vary from slice to slice. User equipment can concurrently access multiple network slices 240. Some embodiments of user equipment provide Network Slice Selection Assistance Information (NSSAI) parameters to the network to assist in selection of a slice instance for the user equipment. A single NSSAI may lead to the selection of several network slices 240. The NFV architecture 200 can also use device capabilities, subscription information and local operator policies to do the selection. An NSSAI is a collection of smaller components, Single-NSSAIs (S-NSSAI), which each include a Slice Service Type (SST) and possibly a Slice Differentiator (SD). Slice service type refers to an expected network behavior in terms of features and services (e.g., specialized for broadband or massive IoT), while the slice differentiator can help selecting among several network slice instances of the same type, e.g. to isolate traffic related to different services into different network slices 240.

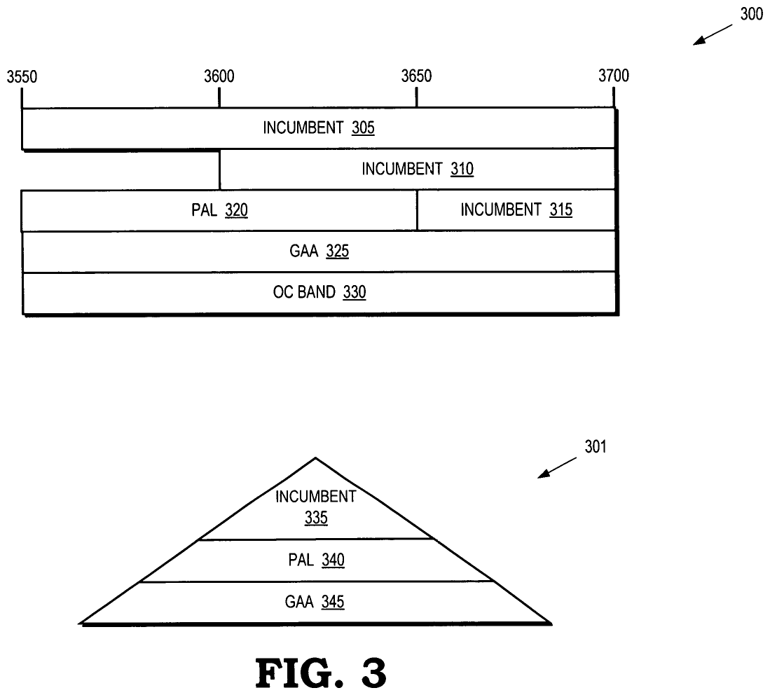

FIG. 3 is a block diagram illustrating an allocation 300 of frequency bands and an access priority 301 for incumbents, licensed users, and general access users according to some embodiments. The allocation 300 and the access priorities 301 are used to determine whether CBSDs such as the base stations 131-133 shown in FIG. 1 are given permission to establish a wireless communication links in portions of the frequency band. The frequency band extends from 3550 MHz to 3700 MHz and therefore corresponds to the spectrum allocated for CBRS. An SAS such as the SAS instance 115 shown in FIG. 1 allocates portions of the frequency band to devices for providing wireless connectivity within a geographic area. For example, the SAS can allocate 20-40 MHz portions of the frequency band to different devices for use as communication channels.

Portions of the frequency band are allocated to incumbent federal radio location devices, such as Navy ships, from the block 305, which corresponds to all of the frequencies in the available frequency band. Portions of the frequency band are allocated to incumbent FSS receive-only earth stations from the block 310. Portions of the frequency band are allocated to grandfathered incumbent wireless broadband services from the block 315. As discussed herein, the portions of the frequency band are allocated from the blocks 305, 310, 315 for exclusive use by the incumbent.

Operators that have received a priority access license (PAL) consistent with 47 CFR § 96.23, et seq. are able to request allocation of portions of the frequency band in the block 320. The portion of the frequency band that is allocated to an operator holding a PAL is available for exclusive use by the operator in the absence of any incumbents in an overlapping frequency band and geographic area. For example, the SAS can allocate a PAL channel in any portion of the entire 150 MHz of CBRS band as long as it is not pre-empted by the presence of an incumbent. Portions of the frequency band within the block 325 are available for allocation to general authorized access (GAA) operators that are authorized to implement one or more CBSDs consistent with 47 CFR § 96.33, et seq. The GAA operators provide wireless connectivity in the allocated portion in the absence of any incumbents or PAL licensees on an overlapping frequency band and geographic area. The GAA operators are also required to share the allocated portion with other GAA operators, if present. Portions of the frequency band within the block 330 are available to other users according to protocols defined by the Third Generation Partnership Project (3GPP).

The access priority 301 indicates that incumbents have the highest priority level 335. Incumbents are therefore always granted exclusive access to a request to portion of the frequency band within a corresponding geographic area. Lower priority operators are required to vacate the portion of the frequency band allocated to the incumbents within the geographic area. The access priority 301 indicates that PAL licensees have the next highest priority level 340, which indicates that PAL licensees receive exclusive access to an allocated portion of the frequency band in the absence of any incumbents. The PAL licensees are also entitled to protection from other PAL licensees within defined temporal, geographic, and frequency limits of their PAL. The GAA operators (and, in some cases, operators using other 3GPP protocols) received the lowest priority level 345. The GAA operators are therefore required to vacate portions of the frequency band that overlap with portions of the frequency band allocated to either incumbents or PAL licensees within an overlapping geographic area.

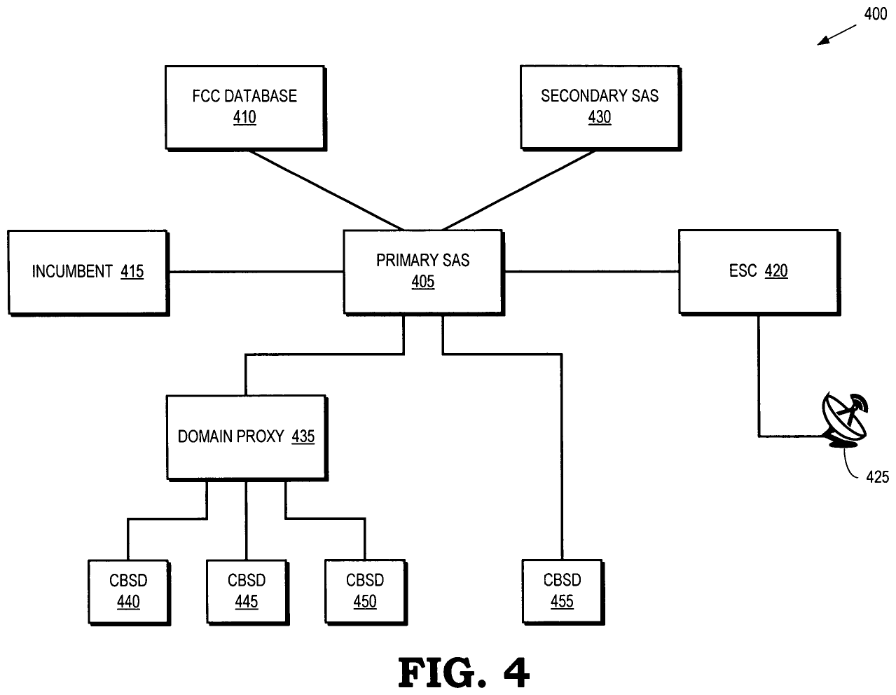

FIG. 4 is a block diagram of a communication system 400 that implements tiered spectrum access according to some embodiments. In the illustrated embodiment, the communication system 400 implements tiered spectrum access in the 3550-3700 CBRS band via a WInnForum architecture. The communication system 400 includes an SAS instance 405 that performs operations including incumbent interference determination and channel assignment, e.g., for CBRS channels shown in FIG. 3. In the illustrated embodiment, the SAS instance 405 is selected as a primary SAS. An FCC database 410 stores a table of frequency allocations that indicate frequencies allocated to incumbent users and PAL licensees. An informing incumbent 415 provides information indicating the presence of the incumbent (e.g., a coverage area associated with the incumbent, and allocated frequency range, a time interval, and the like) to the SAS instance 405. The SAS instance 405 allocates other portions of the frequency range to provide exclusive access to the informing incumbent 415 within the coverage area. An environmental sensing capability (ESC) 420 performs incumbent detection to identify incumbents using a portion of a frequency range within the geographic area, e.g., using a radar sensing apparatus 425. Some embodiments of the SAS instance 405 are connected to other SAS instance 430, e.g., a secondary SAS instance 430. The primary and secondary SAS instance 405, 430 are connected via corresponding interfaces so that the SAS instance 405, 430 coordinate allocation of portions of the frequency range in geographic areas or time intervals.

A domain proxy 435 mediates communication between the SAS instance 405 and one or more CBSD 440, 445, 450 via corresponding interfaces. The domain proxy 435 receives channel access requests from the CBSDs 440, 445, 450 and verifies that the CBSDs 440, 445, 450 are permitted to request channel allocations from the SAS instance 405. The domain proxy 435 forwards requests from the permitted CBSDs 440, 445, 450 to the SAS instance 405. In some embodiments, the domain proxy 435 aggregates the requests from the permitted CBSDs 440, 445, 450 before providing the aggregated request to the SAS instance 405. The domain proxy 435 aggregates requests based on an aggregation function that is a combination of two parameters: (1) a maximum number of requests that can be aggregated into a single message and (2) a maximum wait duration for arrival of requests that are to be aggregated into a single message. For example, if the wait duration is set to 300 ms and the maximum number of requests is 500, the domain proxy accumulates receive requests until the wait duration reaches 300 ms or the number of accumulated requests which is 500, whichever comes first. If only a single request arrives within the 300 ms wait duration, the “aggregated” message includes a single request.

Thus, from the perspective of the SAS instance 405, the domain proxy 435 operates as a single entity that hides or abstracts presence of the multiple CBSDs 440, 445, 450 and conveys communications between the SAS instance 405 and the CBSDs 440, 445, 450. One or more CBSD 455 (only one shown in the interest of clarity) are connected directly to the SAS instance 405 and can therefore transmit channel access requests directly to the SAS instance 405. Additional discussion of this architecture is provided in Appendix B, from the Wireless Innovation Forum, entitled “Requirements for Commercial Operation in the U.S. 3550-3700 MHz Citizens Broadband Radio Service Band”, Working Document WINNF-TS-0112, Version V1.4.130, Jan. 16, 2018, which is incorporated by reference herein in its entirety.

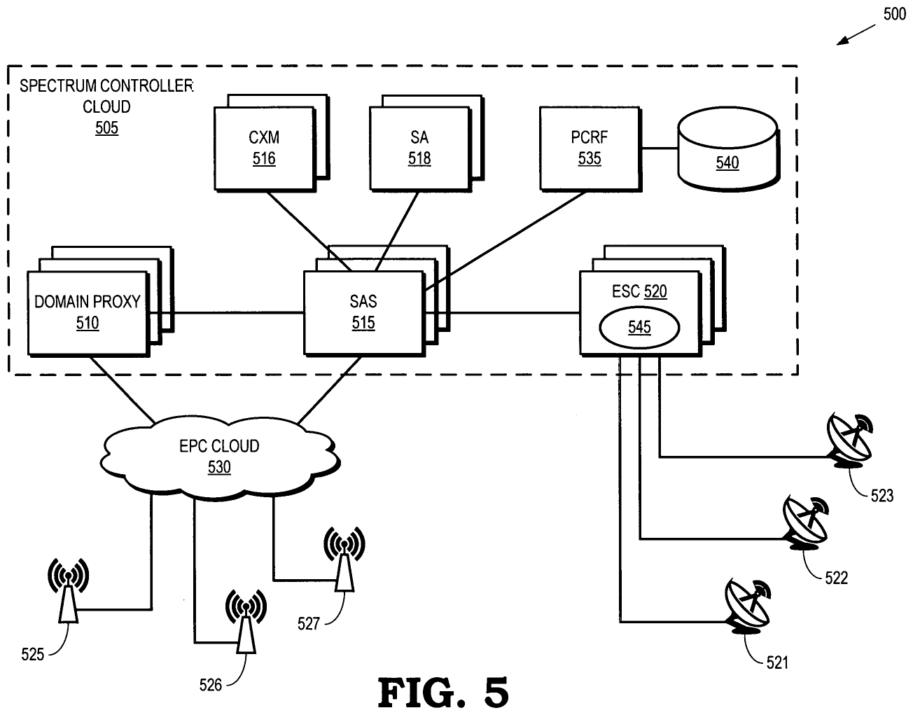

FIG. 5 is a block diagram of a communication system 500 that implements a spectrum controller cloud 505 to support deployment of private enterprise networks in a shared spectrum according to some embodiments. The spectrum controller cloud 505 instantiates multiple instances of domain proxies 510 that support one or more private enterprise networks. The spectrum controller cloud 505 also instantiates multiple SAS instances 515 that support one or more private enterprise networks. Although not shown in FIG. 5, the SAS instances 515 can be connected to other SAS instances, e.g., in other clouds, via corresponding interfaces. Coexistence management (CXM) functions 516 and spectrum analytics (SA) functions 518 are also instantiated in the spectrum controller cloud 505.

One or more ESC instances 520 are instantiated and used to detect the presence of incumbents. In the illustrated embodiment, standalone ESC sensors 521, 522, 523 (collectively referred to herein as “the sensors 521-523”) are used to monitor a frequency band to detect the presence of an incumbent such as a Navy ship. The ESC instances 520 notify the corresponding instance of the SAS instance 515 in response to detecting the presence of an incumbent in a corresponding geographic area. The SAS instance 515 is then able to instruct non-incumbent devices that serve the geographic area to vacate portions of the spectrum overlapping with the spectrum allocated to the incumbent, e.g., by defining a DPA. As discussed herein, some embodiments of the SAS instance 515 register with an ESC cloud to provide ESC services for the SAS instance 515 (or an SAS administrator for the SAS instance 515). Thus, although FIG. 5 depicts the SAS instance 515 and the ESC instances 520 as part of the same spectrum controller cloud 505, the ESC instances 520 are not necessarily deployed in the same location or controlled by the same vendor or provider as the SAS instances 515.

One or more base stations 525, 526, 527 (collectively referred to herein as “the base stations 525-527”) in a private enterprise network communicate with one or more of the domain proxies 510 and the SAS instances 515 via an evolved packet core (EPC) cloud 530. The base stations 525-527 have different operating characteristics. For example, the base station 525 operates according to a PAL in the 3.5 GHz frequency band, the base station 526 operates according to GAA in the 3.5 GHz frequency band, and the base station 525 operates according to a PAL and GAA in the 3.5 GHz frequency band. The base stations 525-527 are configured as Category A (indoor operation with a maximum power of 30 dBm), Category B (outdoor operation with a maximum power of 47 dBm), or CPE. However, in other embodiments, one or more of the base stations 525-527 are configured as either Category A, Category B, or CPE. The EPC cloud 530 provides functionality including LTE EPC operation support system (OSS) functionality, analytics such as traffic analytics used to determine latencies, and the like.

The spectrum controller cloud 505 also includes a policy control and rules function (PCRF) 535 that creates policy rules and makes policy decisions for network subscribers in real-time. The PCRF 535 supports service data flow detection, policy enforcement, and flow-based charging. Some embodiments of the PCRF 535 determine the policy and charging records for SAS service to the CBRS RAN providers who sign up to receive the SAS service. Policies created or accessed by the PCRF 535 for network subscribers are stored in a corresponding database 540 in records associated with the different subscribers.

Some embodiments of the ESC 520 include, or are associated with, a charging function 545 that creates policies for charging the SAS instance 515 (or corresponding SAS administrator) for usage of the ESC instances 520. The charging function 545 tracks usage of the ESC service provided to the SAS administrators such as ESC service minutes (or other granularity) that are charged to the SAS administrators. The charging policies are created in response to the SAS instance 515 (or corresponding SAS administrator) registering with the ESC 520, which then provides ESC services for the registered SAS instance 515. In some embodiments, multiple instances of the SAS instance 515 are deployed that manage CBSDs that are deployed within the same DPA and therefore require the same ESC services from the ESC 520 for the DPA. The ESC usage/charging policies created by the charging function 545 include charging policies that are used to determine a service time interval that indicates a level of granularity that is mandated by a service level agreement associated with registration of the SAS instance 515 with the ESC 520. As used herein, the term “service time interval” refers to a smallest unit of time that can be separately billed or charged to an administrator that owns or operates the SAS instance 515 that is registered with the ESC 520 to provide ESC services. The granularity of the service time interval can be a minute, an hour, a day, a month, or any other larger or smaller interval of time.

As discussed herein, the ESC 520 increments a usage of ESC services by the SAS instance 515 in response to the ESC 520 receiving information (such as a heartbeat message) indicating that the SAS instance 515 has an active connection with the ESC 520 during the service time interval. If multiple instances of the SAS instance 515 are deployed within the same DPA, the ESC 520 increments the usage if at least one of the SAS instance 515 within the DPA has an active connection during the service time interval. The ESC 520 does not increment the usage if no instances of the SAS instance 515 does not have an active connection with the ESC 520 during the service time interval. The ESC 520 charges an administrator of the SAS instance 515 a cost based on the usage determined by the ESC 520.

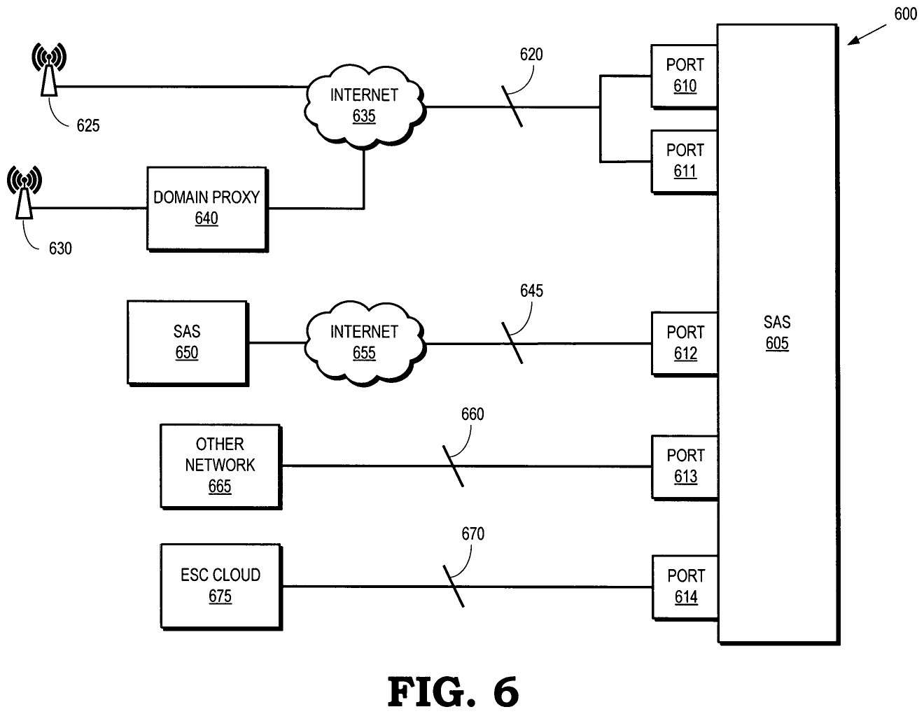

FIG. 6 is a block diagram of communication system 600 including interfaces between CBSDs and an SAS instance 605 according to some embodiments. The SAS instance 605 is used to implement some embodiments of the SAS instance 115 shown in FIG. 1, the SAS instance 405, 430 shown in FIG. 4, and the instances of the SAS instance 515 shown in FIG. 5. The SAS instance 605 includes ports 610, 611, 612, 613, 614 (collectively referred to herein as “the ports 610-614”) that provide access to the SAS instance 605.

An interface 620 supports communication between the SAS instance 605 and CBSDs 625, 630 via a network such as the Internet 635 and the ports 610, 611. The CBSD 625 is connected directly to the SAS instance 605 via the interface 620. The CBSD 630 is connected to the SAS instance 605 via a domain proxy 640 that is connected to the SAS instance 605 by the interface 620. The domain proxy 640 corresponds to some embodiments of the domain proxy 130 shown in FIG. 1, the domain proxy 435 shown in FIG. 4, and the instances of the domain proxy 510 shown in FIG. 5. An interface 645 supports communication between the SAS instance 605 and one or more other SAS instance 650 (only one shown in FIG. 6 in the interest of clarity) via a network such as the Internet 655 and the port 612. The SAS instance 650 can be owned and operated by other providers. An interface 660 supports communication between the SAS instance 605 and one or more other networks 665 (only one shown in FIG. 6 in the interest of clarity) via the port 613. An interface 670 supports communication between the SAS instance 605 and an ESC cloud 675 that provides ESC services to the SAS instance 605, e.g., within a DPA associated with the SAS instance 605.

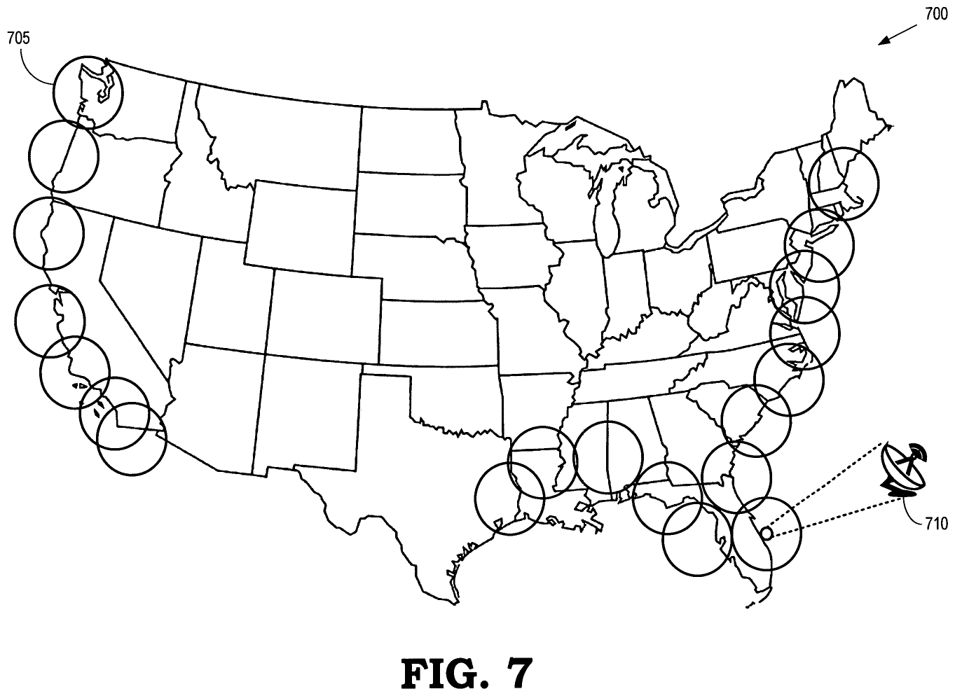

FIG. 7 is a map 700 of the borders of the United States that illustrates a set of DPAs defined at different geographic locations within the United States according to some embodiments. The DPAs 705 (only one indicated by a reference numeral in the interest of clarity) are typically, but not necessarily, defined near coastal regions to protect incumbents such as Navy ships. A DPA 705 can only be deactivated by an operational ESC sensor and consequently any communication system that uses the CBRS spectrum must include an ESC sensor, such as the ESC sensor 710, to have full access to the CBRS spectrum. The ESC sensors 710 is also required to maintain an exchange of heartbeat messages with the ESC cloud that in turn connects with one or more SAS instances to verify that the ESC sensors 710 within the DPA 705 are operational. If there are no operational ESC sensors deployed within a DPA, FCC rules require that the DPA must be activated throughout the entire 150 MHz CBRS spectrum. Moreover, no outdoor CBSDs (Category B) can be deployed in a DPA without an ESC sensor in the DPA.

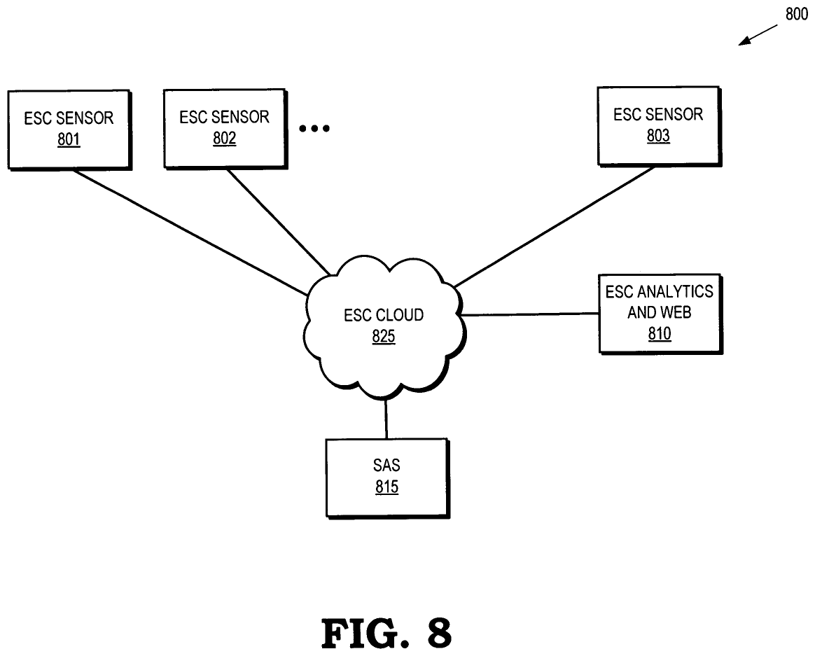

FIG. 8 is a block diagram of a cloud infrastructure 800 that is used to perform environmental sensing within a geographic area such as a DPA according to some embodiments. The cloud infrastructure 800 is implemented in some embodiments of the communication system 100 shown in FIG. 1, the communication system 400 shown in FIG. 4, the communication system 500 shown in FIG. 5, and the communication system 600 shown in FIG. 6. The cloud infrastructure includes a plurality of ESC sensors 801, 802, 803, which are collectively referred to herein as “the ESC sensors 801-803.” In operation, the ESC 801-803 sensors conduct sweeps over the shared CBRS spectrum, e.g., using a single 150 MHz Fast Fourier Transform (FFT) as well as more fine-grained FFTs over resolution bandwidths that are configurable from 1-10 MHz. The ESC sensors 801-803 perform local analyses such as spectral energy estimation, threshold detection, spectral feature analysis, and detection on time averaged spectrograms. The results of the slow scanning using the 150 MHZ FFT, fast scanning using the fine grained FFTs, and local analyses are used to create a first estimate of radar activity.

An ESC cloud 805 collects, combines, and analyzes sensor data acquired by the ESC sensors 801-803, as well as the local analyses performed by the ESC sensors 801-803. The ESC cloud 805 provides the aggregated data and analyses to a web interface 810 for ESC analytics and administration. The ESC cloud 805 also provides the aggregated data and analyses to a corresponding SAS instance 815 that is registered to receive ESC services from the ESC cloud 805. Some embodiments of the SAS instance 815 register to receive SAS services from the ESC cloud 805 for a corresponding DPA. The ESC cloud 805 also determines a usage of the ESC services by the SAS instance 815. The ESC cloud 805 and the SAS instance 815 exchange heartbeat messages at a negotiated periodicity or time interval. The ESC cloud 805 increments the ESC usage for the SAS instance 815 in response to successfully exchanging at least one heartbeat message with the SAS instance 815 in a predetermined (service) time interval. For example, the ESC cloud 805 increments the ESC usage per DPA by one minute in response to successful exchange of one or more heartbeat messages with the SAS instance 815 during a service time interval of one minute as long as the ESC sensors in the DPA are operational.

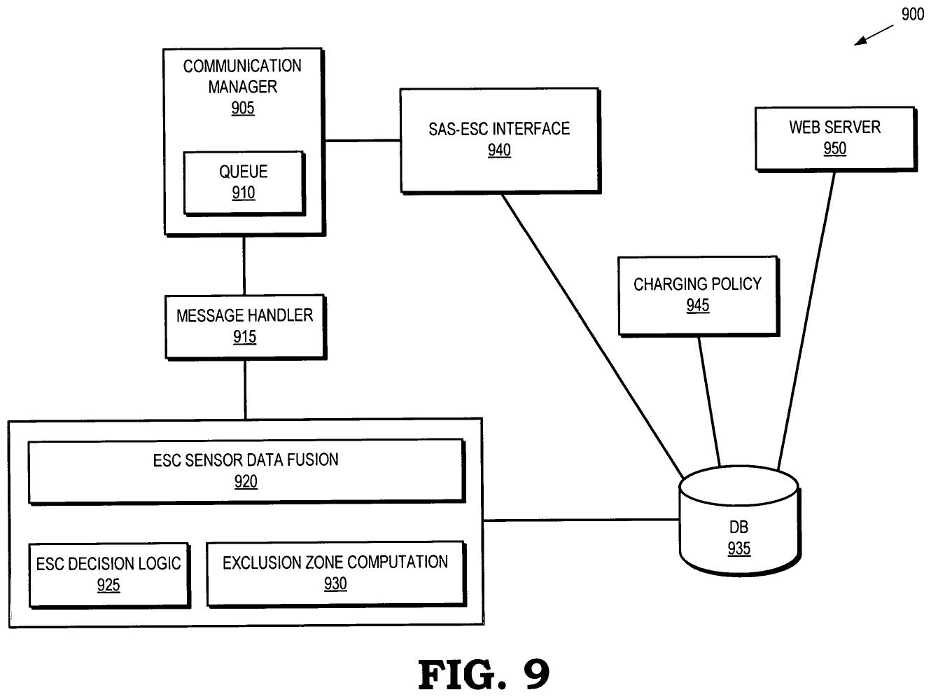

FIG. 9 is a block diagram of an ESC cloud 900 according to some embodiments. The ESC cloud 900 is used to implement some embodiments of the ESC cloud 805 shown in FIG. 8. The ESC cloud 900 includes a communication manager 905 that provides an interface to one or ESC sensors, such as the ESC sensors 801-803 shown in FIG. 8. The communication manager 905 includes a message queue 910 that holds messages prior to transmitting the messages to the ESC sensors and holds messages received from the ESC sensors prior to distributing the messages to other entities in the ESC cloud 900, such as a message handler layer 915.

Messages received from the ESC sensors are provided to an ESC sensor data fusion block 920 that aggregates information received from the ESC sensors. In some embodiments, the information includes data acquired by the ESC sensors and results of local analyses performed by the ESC sensors. An ESC decision logic 925 uses the information generated by the ESC sensor data fusion block 920 to determine whether an incumbent is present in the region, such as a DPA that is monitored by the ESC sensors in the ESC cloud 900. The ESC decision logic 925 also uses the information to determine the portion of the spectrum (out of the total 150 MHz CBRS band) that is impacted by the presence of the incumbent. An exclusion zone computation block 930 uses the information generated by the ESC sensor data fusion block 920 and the ESC decision logic 925 to determine whether an incumbent is present and has priority within a geographic area such as a DPA. Information generated by the blocks 920, 925, 930 is stored in a database 935.

The communication manager 905 also exchanges messages with an SAS-ESC interface 940 that provides an interface between the ESC cloud 900 and one or more SAS instances that are registered with the ESC cloud 900. The messages include heartbeat messages exchanged between the ESC cloud 900 and the registered SAS instances. The heartbeat messages, or information representative thereof, such as timestamps that indicate successful exchange of heartbeat messages, are provided to the database 935 for storage. The charging policies 945, such as charging policies for use of the ESC services provided by the ESC cloud 900, are also provided to the database 935, which is connected to a Web server interface 950 to external entities such as an ESC analytics and administration interface. The information stored in the database 935 is used to determine usages for the SAS instances that are registered to receive the ESC services. In some cases, the usages are determined per DPA using information that associates the SAS instances with corresponding DPAs.

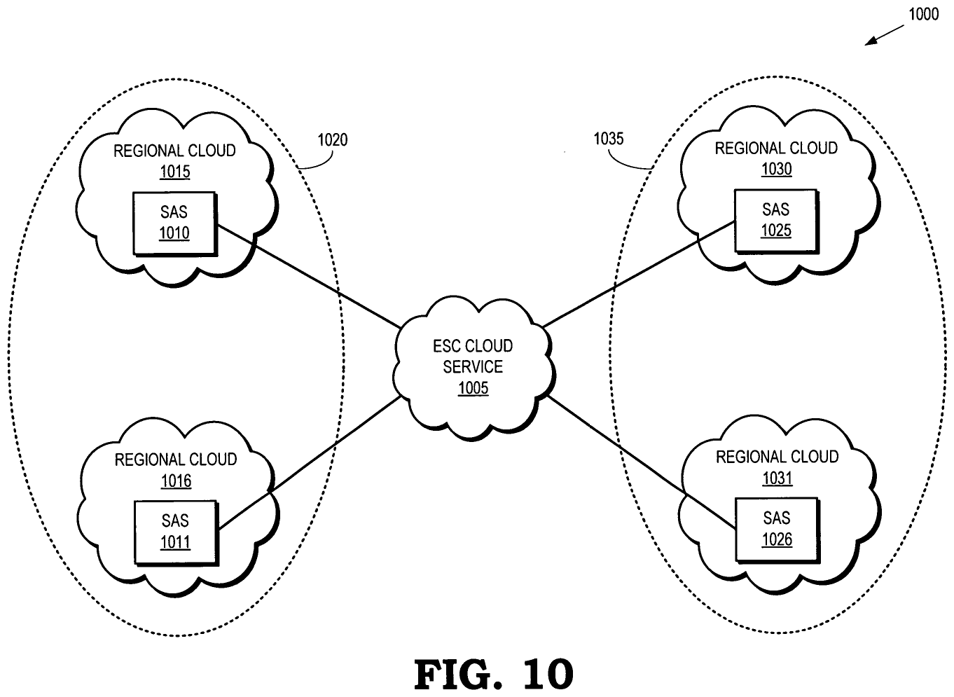

FIG. 10 is a block diagram of a communication system 1000 that includes an ESC cloud service 1005 to provide ESC services to registered SAS administrators according to some embodiments. The ESC cloud service 1005 is implemented using some embodiments of the ESC cloud 900 shown in FIG. 9. In the illustrated embodiment, two SAS administrators are registered to receive ESC services from the ESC cloud service 1005. In some cases, more than two SAS administrators register with the ESC cloud to receive the ESC service to deploy a CBRS RAN in a DPA, with each having more than two geo redundant SAS instances. In the interest of clarity, only two SAS administrators having two geo-redundant SAS instances are shown in FIG. 10. The first SAS administrator has registered SAS instances 1010, 1011 in corresponding regional clouds 1015, 1016, as indicated by the dashed oval 1020. In the illustrated embodiment, the first SAS administrator registers the SAS instances 1010, 1011 to receive ESC services within a first DPA. The second SAS administrator has registered SAS instances 1025, 1026 in corresponding regional cloud 1030, 1031, as indicated by the dashed oval 1035. In the illustrated embodiment, the second SAS administrator registers the SAS instances 1025, 1026 to receive ESC services within a second DPA.

The ESC cloud service 1005 computes usage for the first and second SAS administrators on a per-DPA basis. The ESC cloud service 1005 exchanges heartbeat messages with the SAS instances 1010, 1011 for the first SAS administrator and the SAS instances 1025, 1026 for the second SAS administrator. Usage is computed in service time intervals that have a predetermined granularity, such as a minute, an hour, or a day. The usage is incremented for the first or second SAS administrator if heartbeat messages are successfully exchanged with at least one of the corresponding SAS instances 1010, 1011, 1025, 1026 during a service time interval. For example, the usage for the first SAS administrator (in the first DPA) is incremented if heartbeat messages are successfully exchanged with the SAS instance 1025, the SAS instance 1026, or both SAS instances 1025, 1026 during a service time interval. The usage for the first SAS administrator is not incremented if no heartbeat messages are successfully exchanged with either the SAS instance 1025 or the SAS instance 1026 during the service time interval. If the ESC cloud loses connectivity with ESC sensor in a DPA, the ESC service minute is not incremented for a registered SAS instance even though there may be successful heartbeat exchange between the ESC cloud and the SAS instance.

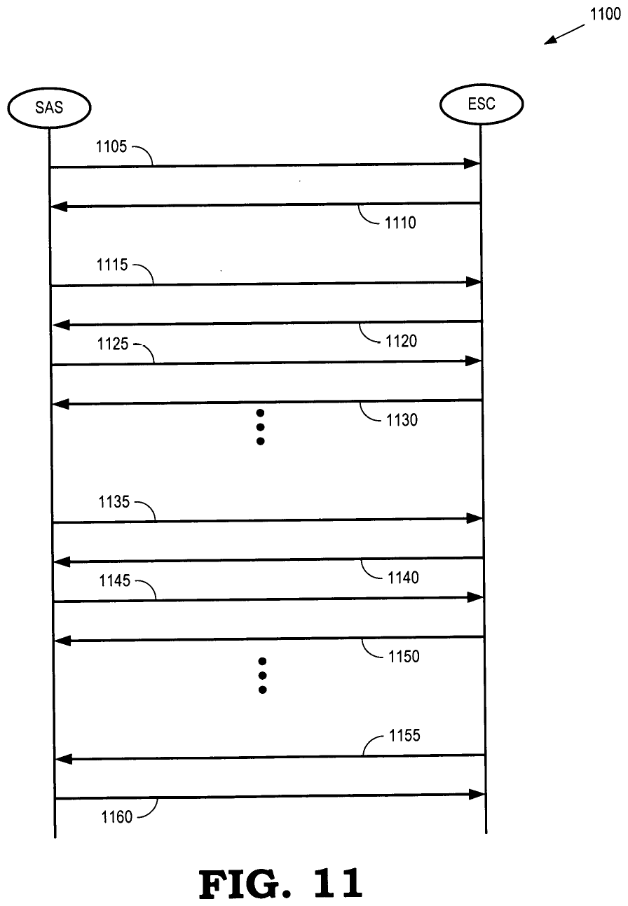

FIG. 11 illustrates a message sequence 1100 for messages exchanged between an SAS and an ESC cloud according to some embodiments. The message sequence 1100 is used in some embodiments of the communication system 100 shown in FIG. 1, the communication system 400 shown in FIG. 4, the communication system 500 shown in FIG. 5, the communication system 600 shown in FIG. 6, the cloud infrastructure 800 shown in FIG. 8, and the communication system 1000 shown in FIG. 10.

The SAS transmits a registration request message 1105 to request registration with the ESC cloud to receive ESC services for an associated DPA. In response to receiving the registration request 1105, the ESC cloud transmits a registration response message 1110, which indicates whether the registration of the SAS was successful and, if so, specifies a periodicity or time interval of heartbeat messages that are exchanged between the ESC cloud and the SAS. The heartbeat duration is programmable, e.g., the periodicity of the heartbeat messages can be set to once every 20 seconds, once every 30 seconds, once every minute, and the like.

The SAS transmits a heartbeat message 1115 to the ESC cloud, which responds with a heartbeat response 1120. After waiting for the negotiated time interval, the SAS transmits another heartbeat message 1125 to the ESC cloud, which responds with a heartbeat response 1130. The exchange of heartbeat messages continues as long as the connection between the ESC cloud in the SAS is available and the SAS is registered with the ESC cloud to receive the ESC services. As discussed herein, the ESC cloud determines usage of the ESC services by the SAS in the DPA based on the heartbeat messages that are received during each service time interval.

Some embodiments of the SAS transmit a periodic ESC sensor status request 1135 to request status information from the ESC cloud such as information indicating whether an incumbent is present in the DPA, and if so the portion of the CBRS spectrum that is impacted by its presence. In response to receiving the ESC sensor status request 1135, the ESC cloud transmits a periodic ESC sensor status response 1140 that includes information indicating the current status of the ESC cloud. After waiting for a time interval corresponding to a periodicity of the requests, which is typically but not necessarily different than the periodicity of the heartbeat messages, the SAS transmits another periodic ESC sensor status request 1145 and the ESC cloud responds with another periodic ESC sensor status response 1150.

The ESC cloud may also asynchronously report the presence or absence of an incumbent and an impacted frequency range by transmitting an asynchronous ESC sensor status 1155 including information indicating the presence of the incumbent and the impacted frequency range. In response to receiving the asynchronous ESC sensor status 1155, the SAS transmits an asynchronous ESC sensor status response 1160.

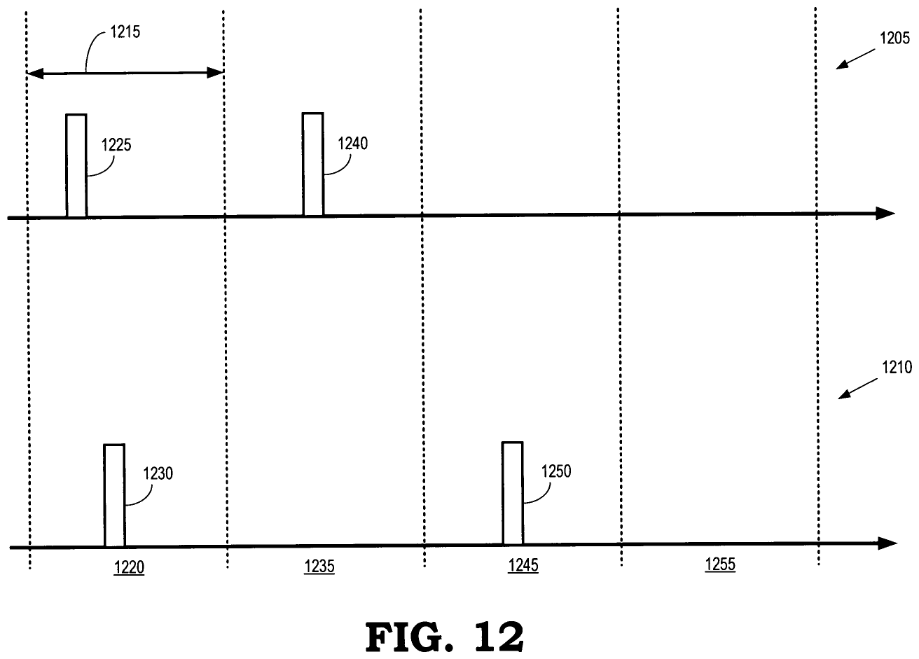

FIG. 12 illustrates a heartbeat message exchange between an ESC cloud and two SAS instances that manage CBSDs that are deployed in a DPA according to some embodiments. The heartbeat message exchange is used in some embodiments of the communication system 100 shown in FIG. 1, the communication system 400 shown in FIG. 4, the communication system 500 shown in FIG. 5, the communication system 600 shown in FIG. 6, the cloud infrastructure 800 shown in FIG. 8, and the communication system 1000 shown in FIG. 10. The heartbeat messages exchanged between the ESC cloud and a first SAS instance are indicated in the sequence 1205 and the heartbeat messages exchanged between the ESC cloud and a second SAS instance are indicated in the sequence 1210. The first and second SAS instances are registered on behalf of the same SAS administrator for managing CBSDs that are deployed within the same DPA. The ESC cloud computes a usage of the ESC service provided by the ESC cloud at a granularity determined by a service time interval 1215.

During a first service time interval 1220, the ESC cloud successfully exchanges a heartbeat message 1225 with the first SAS instance and a heartbeat message 1230 with the second SAS instance. Since a heartbeat message was successfully exchanged with at least one of the SAS instances, the ESC cloud increments the usage for the SAS administrator in the DPA by an amount that corresponds to one service time interval.

During a second service time interval 1235, the ESC cloud successfully exchanges a heartbeat message 1240 with the first SAS instance. The ESC cloud does not successfully exchange a heartbeat message with the second SAS instance during the service time interval 1235. However, the ESC cloud increments the usage for the SAS administrator in the DPA for the service time interval 1235 because the ESC cloud successfully exchanged a heartbeat message with at least one of the SAS instances associated with the SAS administrator in the DPA during the service time interval 1235.

During a third service time interval 1245, the ESC cloud successfully exchanges a heartbeat message 1250 with the second SAS instance. The ESC cloud does not successfully exchange a heartbeat message with the first SAS instance during the service time interval 1245. However, the ESC cloud increments the usage for the SAS administrator in the DPA for the service time interval 1245 because the ESC cloud successfully exchanged a heartbeat message with at least one of the SAS instances associated with the SAS administrator in the DPA during the service time interval 1245.

During a fourth service time interval 1255, the ESC cloud does not successfully exchange a heartbeat message with either the first SAS instance or the second SAS instance. The ESC cloud therefore does not increment the usage for the SAS administrator in the DPA for the service time interval 1255. If the ESC cloud loses connectivity with its ESC sensors that are deployed in a DPA, it does not increment the ESC service usage for a SAS administrator.

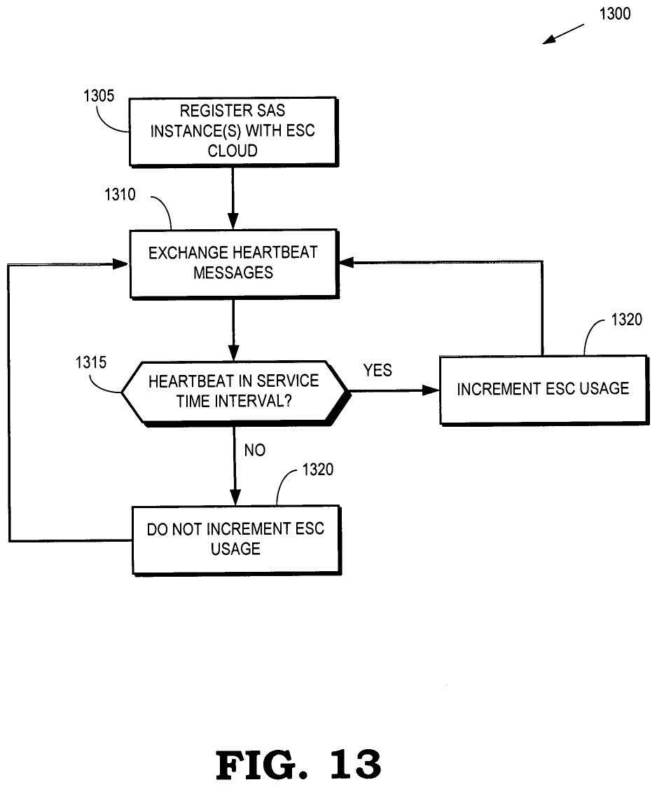

FIG. 13 is a flow diagram of a method 1300 for determining usages of an ESC service by SAS instances that manage CBSDs that are deployed in a DPA according to some embodiments. A SAS administrator may register itself to receive ESC service in multiple DPAs. The ESC service usage is therefore determined on a per DPA basis. The method 1300 is implemented in some embodiments of the communication system 100 shown in FIG. 1, the communication system 400 shown in FIG. 4, the communication system 500 shown in FIG. 5, the communication system 600 shown in FIG. 6, the cloud infrastructure 800 shown in FIG. 8, and the communication system 1000 shown in FIG. 10.

At block 1305 one or more SAS instances are registered with an ESC cloud to receive ESC services in a corresponding DPA. The SAS instances are registered using some embodiments of the message exchange 1100 shown in FIG. 11.

At block 1310, the SAS instances and the ESC cloud exchange heartbeat messages at a predetermined periodicity. In some embodiments, the periodicity of the heartbeat messages is negotiated between the SAS instances and the ESC cloud during the registration process.

At decision block 1315, the ESC cloud determines whether a heartbeat message was successfully exchanged with at least one of the SAS instances during a service time interval and if the ESC sensors in the DPA are operational. If a heartbeat message was successfully exchanged, the method 1300 flows to block 1320 and the ESC usage for the DPA is incremented by an amount that corresponds to the service time interval only if the ESC sensors are operational in the DPA in that time interval. If no heartbeat messages were successfully exchanged with the SAS instances, the method flows to block 1325 and the ESC usage for the DPA is not incremented. The method 1300 then continues to monitor the exchange of heartbeat messages during subsequent service time intervals.

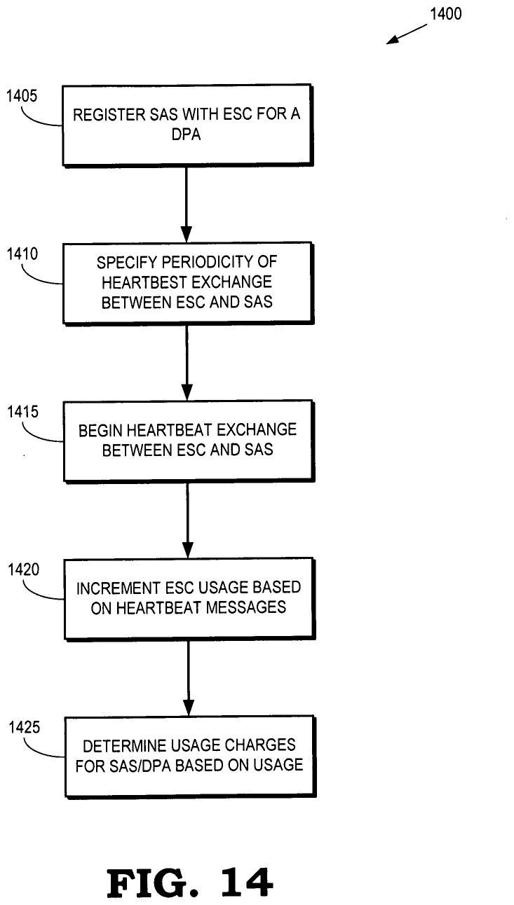

FIG. 14 is a flow diagram of a method 1400 for determining usage charges for an ESC service provided to SAS instances in a DPA according to some embodiments. The method 1400 is implemented in some embodiments of the communication system 100 shown in FIG. 1, the communication system 400 shown in FIG. 4, the communication system 500 shown in FIG. 5, the communication system 600 shown in FIG. 6, the cloud infrastructure 800 shown in FIG. 8, and the communication system 1000 shown in FIG. 10.

At block 1405, one or SAS instances are registered with an ESC cloud to receive ESC services within the DPA. At block 1410, a periodicity for the exchange of heartbeat messages between the ESC cloud and the SAS instances is specified. In some embodiments, the periodicity is determined during a registration procedure such as the registration procedure illustrated by the message exchange 1100 disclosed in FIG. 11.

At block 1415, the heartbeat exchange begins between the ESC cloud and the registered instances of the SAS. At block 1420, the ESC cloud increments and ESC usage for the DPA based on the heartbeat exchange. As discussed herein, the ESC usage for the DPA is only incremented if at least one of the SAS instances in the DPA successfully exchanged a heartbeat message with the ESC during the corresponding service time interval only if the ESC sensors in the DPA are operational.

At block 1425, the ESC cloud (or other charging entity) determines usage charges for the SAS in the DPA based on the usage that is determined from the heartbeat message exchange between the ESC and the SAS instances.

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

As used herein, the term “circuitry” may refer to one or more or all of the following:
a) hardware-only circuit implementations (such as implementations and only analog and/or digital circuitry) and
b) combinations of hardware circuits and software, such as (as applicable):
   (i) a combination of analog and/or digital hardware circuit(s) with software/firmware and
   (ii) any portions of a hardware processor(s) with software (including digital signal processor(s), software, and memory(ies) that work together to cause an apparatus, such as a mobile phone or server, to perform various functions) and
c) hardware circuit(s) and/or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in a server, a cellular network device, or other computing or network device.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. An apparatus comprising:
a transceiver configured to exchange heartbeat messages with at least one spectrum access server (SAS) that is registered to receive environmental sensing capability (ESC) services for a shared spectrum; and
a processor configured to increment an ESC usage for the at least one SAS in response to successfully exchanging at least one heartbeat message with the at least one SAS in a predetermined time interval.

2. The apparatus of claim 1, wherein the transceiver is configured to receive a registration message for the at least one SAS, and wherein the processor is configured to provide the ESC services to the at least one SAS in response to receiving the registration message.

3. The apparatus of claim 2, wherein the registration message indicates a dynamic protection area (DPA) that defines a local protection area that is activated or deactivated to protect Department of Defense (DOD) radar systems in the shared spectrum.

4. The apparatus of claim 3, wherein the ESC usage indicates usage of the ESC services provided within the DPA.

5. The apparatus of claim 4, wherein the transceiver is configured to receive a plurality of registration messages for a plurality of SAS instances that are associated with an SAS administrator, and wherein the processor is configured to provide the ESC services to the plurality of SAS instances within the DPA.

6. The apparatus of claim 5, wherein the processor is configured to increment the ESC usage for the plurality of SAS instances in response to successfully exchanging the at least one heartbeat message with at least one of the plurality of SAS instances during the predetermined time interval.

7. The apparatus of claim 6, wherein the plurality of SAS instances are geo-redundant SAS instances deployed within the DPA.

8. The apparatus of claim 3, wherein the DPA is activated in response to failing to exchange heartbeat messages with the at least one SAS for a timeout interval.

9. The apparatus of claim 2, wherein the registration message indicates a periodicity for exchanging the heartbeat messages.

10. A method comprising:
exchanging, at an environmental sensing capability (ESC) cloud, heartbeat messages with at least one spectrum access server (SAS) that is registered with the ESC cloud to receive ESC services for a shared spectrum; and
incrementing, at the ESC cloud, an ESC usage for the at least one SAS in response to successfully exchanging at least one heartbeat message with the at least one SAS in a predetermined time interval.

11. The method of claim 10, further comprising:
receiving a registration message for the at least one SAS; and
providing the ESC services to the at least one SAS in response to receiving the registration message.

12. The method of claim 11, wherein the registration message indicates a dynamic protection area (DPA) that defines a local protection area that is activated or deactivated as necessary to protect Department of Defense (DOD) radar systems in the shared spectrum.

13. The method of claim 12, wherein the ESC usage indicates usage of the ESC services provided within the DPA.

14. The method of claim 13, wherein receiving the registration message comprises receiving a plurality of registration messages for a plurality of SAS instances that are associated with an SAS administrator, and wherein providing the ESC services comprises providing the ESC services to the plurality of SAS instances within the DPA.

15. The method of claim 14, wherein incrementing the ESC usage comprises incrementing the ESC usage for the plurality of SAS instances in response to successfully exchanging the at least one heartbeat message with at least one of the plurality of SAS instances during the predetermined time interval.

16. The method of claim 15, wherein the plurality of SAS instances are geo-redundant SAS instances deployed within the DPA.

17. The method of claim 12, further comprising:
activating the DPA in response to failing to exchange heartbeat messages with the at least one SAS for a timeout interval.

18. The method of claim 11, wherein the registration message comprises information that indicates a periodicity for exchanging the heartbeat messages.

19. An apparatus comprising:
at least one processor; and
at least one memory including computer program code;
the at least one memory and the computer program code configured to, with the at least one processor, cause the apparatus at least to perform:
exchanging, at an environmental sensing capability (ESC) cloud, heartbeat messages with at least one spectrum access server (SAS) that is registered with the ESC cloud to receive ESC services for a shared spectrum; and
incrementing, at the ESC cloud, an ESC usage for the at least one SAS in response to successfully exchanging at least one heartbeat message with the at least one SAS in a predetermined time interval.

20. The apparatus of claim 19, wherein the at least one memory and the computer program code are configured to, with the at least one processor, cause the apparatus at least to perform:
receiving a registration message for the at least one SAS; and
providing the ESC services to the at least one SAS in response to receiving the registration message.
